(19) United States
(12) Patent Application Publication
(10) Pub. No.: US 2004/0142187 A1
(43) Pub. Date: Jul. 22, 2004

(54) Cemented optical element

(75) Inventor: Naohito Shiga, Tokyo (JP)

Correspondence Address: PILLSBURY WINTHROP, LLP, P.O. BOX 10500, MCLEAN, VA, 22102, US

(73) Assignee: Olympus Corporation, Tokyo (JP)

(21) Appl. No.: 10/752,007

(22) Filed: Jan. 7, 2004

(30) Foreign Application Priority Data
Jan. 8, 2003 (JP) 2003-002384

(51) Int. Cl. B32B 27/00

(52) U.S. Cl. 428/447

(57) ABSTRACT

The present invention provides a cemented optical element which is manufactured by bonding a plurality of optical elements and which has improved thermal characteristics and can be easily manufactured. The cemented optical element comprises optical materials consisting of inorganic material(s) such as optical glass which are bonded to each other via a cementing layer, wherein the cementing layer is made of polysilane.

### BACKGROUND OF THE INVENTION

The present invention relates to a cemented optical element, such as a cemented lens or a cemented prism, comprising optical materials consisting of inorganic material(s) such as optical glass which are bonded to each other via a cementing layer.

Conventionally, cemented optical elements of various kinds have been manufactured by bonding lenses made of optical glass with cement of organic high-molecular substance or by bonding a membrane or an element formed with microfabrication to a cementing surface of an optical material. With increased requirements for specification such as increase in reliability of durability, increase in transmittable range of wavelength, fabrication of membrane under high-temperature condition, and facilitation of bonding and assembly, there are cases the cement of organic high-molecular substance can not sufficiently comply with such requirements.

A fine micro fluid passage element having a fluid passage for instrumental analysis, being capable of performing an optical detection over a range from ultraviolet to visible wavelength, has been proposed in U.S. 2002001695 (JP10288580A), which comprises a flat quarts glass, a quarts glass having a fluid passage formed in at least one face thereof, and a laminated film consisting of a polysilicon thin film, an alkali-ion containing glass layer such as borosilicate glass thin film, and a polysilicon thin film, wherein the laminated film is interposed between the quarts glasses when they are bonded to each other.

A cemented prism of which the optical surface can be coated with an optical film after the optical surfaces are bonded has been proposed in JP07110961A, in which a fusing glass is used as cement for bonding optical surfaces of a plurality of prisms to each other.

A method for manufacturing an optical element by bonding prisms made of silica glass to each other by a hydrolysis product of silicon alcoholate has been proposed in U.S. Pat. No. 5,725,626 (JP2786996B2).

A laser side illuminator comprising an optical fiber for guiding a laser beam and a microchip provided at its tip with a 90° prism-like structure part for allowing the laser beam guided from the optical fiber to be subjected to full reflection to the side has been proposed in JP0788116A, in which both of a core of the optical fiber and the microchip are made of quartz and a joint between the core of the optical fiber and the microchip is obtained by optical contact.

However, such cemented optical element manufactured by bonding at least one optical element to another optical element by using a cement has a problem of failing to obtain stable bonding according the environment such as a high-temperature environment or a problem of complex bonding process.

For example, in U.S. 2002001695 (JP10288580A), there is a problem of complex manufacturing process. That is, three different layers i.e. a polysilicon thin film, a borosilicate glass thin film, and a polysilicon thin film are fabricated by sputtering or the like and, in addition, they are joined at a temperature of 350° C.-500° C. by using an anodic joining apparatus of applying high voltage.

In the cemented prism disclosed in JP07110961, the optical surfaces are bonded with the fusing glass having a low melting point about 300° C. However, the working environment should be high-temperature environment and, in addition, the fusing glass contains lead, titanium, or the like for obtaining its low melting point so that the optical characteristic in a range of short wavelength may be spoiled and the additive such as lead or titanium increases the environmental burden.

In the cement disclosed in U.S. Pat. No. 5,725,626 (JP2786996B2), since the hydrolysis product of silicon alcoholate is used, polycondensation reaction is indispensable. This reaction requires a lot of time and by-products are generated during the reaction, thus easily producing defects such as voids in the cementing layer. In addition, the formed cementing layer is brittle and has a tendency of easily peeling off in case of using materials having different coefficients of linear expansion.

In JP0788116A, the optical contact is adopted for joint between quartzes. To adopt this method, it is necessary to increase the smoothness and cleanliness of the both surfaces in order to achieve the optical contact. Therefore, there is a problem of complex manufacturing process and complex assembling process.

### BRIEF DESCRIPTION OF THE DRAWINGS

FIG. 1 is an illustration for explaining an optical element for instrumental analysis;

FIG. 2 is an illustration for explaining the manufacturing process of the optical element for instrumental analysis shown in FIG. 1;

FIG. 3 is an illustration for explaining the formation of a cementing layer by ultraviolet ray irradiation;

FIG. 4 is an illustration for explaining the formation of a vitrificated layer with a pattern formed by polysilane;

FIG. 5 is an illustration for explaining a cemented optical element manufactured by bonding quartz prisms; and

FIG. 6 is an illustration for explaining a glass manufactured by bonding different vitreous materials.

### SUMMARY OF THE INVENTION

The object of the present invention is achieved by a cemented optical element manufactured by bonding optical materials consisting of inorganic material(s) to each other via a cementing layer, wherein the cementing layer is made of polysilane.

The object is also achieved by a cemented optical element as mentioned above, wherein the optical materials consisting of inorganic material(s) are at least two different materials.

The object is also achieved by a cemented optical element as mentioned above, wherein the cementing layer is polysilane formed by heating.

As mentioned above, the optical materials consisting of inorganic materials are bonded to each other via the cementing layer made of polysilane, thereby providing the cemented optical element of which manufacture is relatively easy and which has high durability even in a high-temperature range and has improved optical characteristics.

Since the cementing layer is made of polysilane, even when different optical materials to be bonded to each other have different coefficients of thermal expansion, the bonding strength at the cementing surfaces thereof can be maintained, thereby expanding the selection of optical materials to be bonded.

The object is also achieved by a cemented optical element as mentioned above, wherein the cementing layer made of polysilane is formed by applying polysilane component containing a photo-curable component on a cementing portion and, after that, photolyze the polysilane component by irradiation of light such as ultraviolet ray.

As mentioned above, since the polysilane component containing a photo-curable component is used, a cementing layer can be formed at any portion by specifying the region to be irradiated with light, thereby manufacturing various cemented optical elements.

Since the cementing layer made of polysilane is formed by heating at a temperature between 250° C. and 350° C. after ultraviolet ray irradiation, the reliability as much as that of inorganic materials such as glass and ceramics can be ensured while remaining the flexibility as the function of polymer.

### DESCRIPTION OF THE PREFERRED EMBODIMENT

The present invention is an element in which optical materials consisting of inorganic material such as glass series, ceramics series, or the like are bonded to each other via a cementing layer made of polysilane. Therefore, the element is characterized by improved various characteristics such as thermal durability as compared to the case using organic material as a cement, less risk of developing vulnerability as compared to the conventional cement of inorganic series, and not containing any substance causing an environmental problem such as lead.

Polysilane used in the present invention will be described. Polysilanes are organic compounds having Si—Si bonds in the main chain and exhibit unusual behavior resulting from the delocalization of σ-electrons of the Si—Si bonds.

Due to functional group to be bonded with Si, the characteristics such as solubility, reactivity, membrane hardness, thick membrane formability, and adhesiveness vary. The functional group is selected from a group consisting of substituted or non-substituted aliphatic hydrocarbon groups such as a methyl group, an n-propyl group, an n-butyl group, an n-hexyl group, a phenylmethyl group, a trifluoropropyl group and a nonafluorohexyl group, substituted or non-substituted alicyclic hydrocarbon groups such as a cyclohexyl group and a methyl cyclohexyl group, and aromatic hydrocarbon groups such as a p-tolyl group, a biphenyl group, and a phenyl group.

In case of an aliphatic or alicyclic hydrogen group, the number of carbons is 1-10, preferably 1-6. In case of an aromatic hydrocarbon group, the number of carbons is 6-14, preferably 6-10. Any of the aforementioned hydrocarbon groups is transparent and colorless and soluble with organic-solvent.

As a polysilane compound containing polysilane is irradiated with heat or ultraviolet energy, the polysilane compound radiates silylene as divalent radical having a structure which is different according to the kind of the substituent. Particularly when the polysilane compound is irradiated with ultraviolet, homolysis of Si—Si bond is also caused. When oxidized with oxygen, the si—Si bond becomes siloxane bond or silanol group that is hydrophilic and acidic site. The larger the distortion is, the easier the phenomenon of becoming hydrophilic and acidic site is caused in a low-temperature environment. The portions which are hydrophilic and acidic site may be fixed reaction fields for various materials.

To improve the sensitivity against photolysis of the polysilane, a sensitizer such as triazine or peroxide may be added, alternatively, a radical photo initiator which generates halogen radical by light may be added. In addition, synergy effect of the radical photo initiator and the oxidant facilitates the insertion of oxygen into Si—Si bonds, thereby further improving the sensitivity against photolysis of the polysilane.

Examples of the radical photo initiator include 2,4,6-tris(trihalomethyl)-1,3,5-triazine, 4,6-bis(trihalomethyl)-1,3,5-triazine having a functional group at Position 2, and 1,3,5-triazine having functional groups at Positions 2, 4. Examples of the oxidant include peroxide, amine oxide, and phosphine oxide.

It is practicable that the radical photo initiator and the oxidant in an amount are added in an amount of 1-30 parts by weight relative to 100 parts by weight of polysilane, respectively. Besides the radical photo initiator and the oxidant, a suitable pigment may be added. In this case, halogen radicals are generated by photoexcitation of the pigment.

The refraction index of the polysilane alone is freely adjustable from 1.55 to 1.75 not only according to the kind of the functional group but also according to the amount of exposure because the main chain is broken due to photolysis to generate silanol and the like.

After applied, the polysilane is evaporated to remove its solvent component, is exposed by ultraviolet, and is heated at a temperature from 250° C.-350° C., preferably on the order of 300° C., whereby the polysilane becomes transparent and obtains flexibility and chemical resistance. If the heating temperature is lower than 250° C., the oxidization can not sufficiently occur so that a large amount of organic component must remain and it is therefore impossible to obtain enough chemical resistance. On the other hand, if the heating temperature exceeds 350° C., production of glass ceramics must proceed, thus developing vulnerability.

Hereinafter, the present invention will be described with reference to Examples.

### EXAMPLE 1

An example of manufacturing an optical element for instrumental analysis shown in FIG. 1 will be described.

The optical element comprises a quartz substrate 1a having a flat surface of which roughness is 5 μm in PV value and a quartz substrate 1b provided with a groove 5 formed in a surface of the cementing side. The quartz substrates 1a, 1b are bonded to each other via a cementing layer 9 made of polysilane. The groove 5 is a fine micro fluid passage for instrumental analysis.

The quartz substrates 1a, 1b are 100 mm×100 mm in size and 1 mm in thickness. Formed in the cementing surface of the quartz substrate 1b is the groove 5 which is 0.1 mm in width and 0.1 mm in depth. The groove 5 can be formed by etching using a hydrofluoric acid or machining using a dicing blade.

Polysilane solution for forming the cementing layer was made by preparing, as a radical photo initiator, 10 parts by weight of 2,4-bis(trichloromethyl)-6-(p-methoxy-phenyl-vinyl)-1,3,5-triazine (TAZ-110 available from Midori Kagaku co., Ltd.) and, as an oxidant, 15 parts by weight of 3,3′,4,4′-tetra-(t-buthyl-peroxy-carbonyl)benzophenone (BTTB available from NOF corporation) relative to 100 parts by weight of polymethyl phenyl silane (weight-average molecular weight is 200 thousand) and causing these components to lyse in toluene to make a toluene solution of 10% by mass.

The polysilane solution was applied on the cementing surface of the quartz substrate 1a without the groove 5 by dip coating and was evaporated its toluene, thereby obtaining a coating layer 6 of 5 μm in thickness.

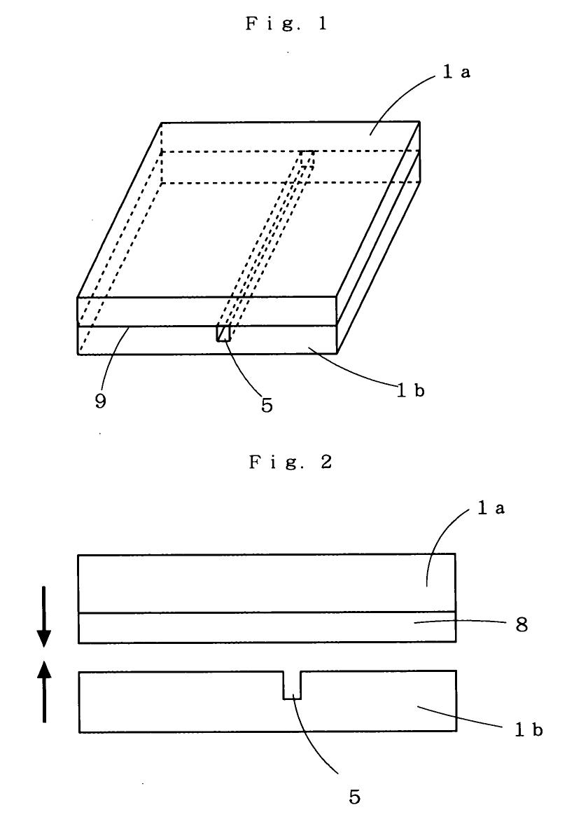

Then, as shown in FIG. 2, the cementing surface of the quartz substrate 1a and the cementing surface of the quartz substrate 1b were bonded to each other with carefully positioning not to allow air entrapment, i.e. bubbles, and dried in a dry kiln at 120° C. for 40 minutes while being pressurized at 5 kPa, whereby the solvent evaporates.

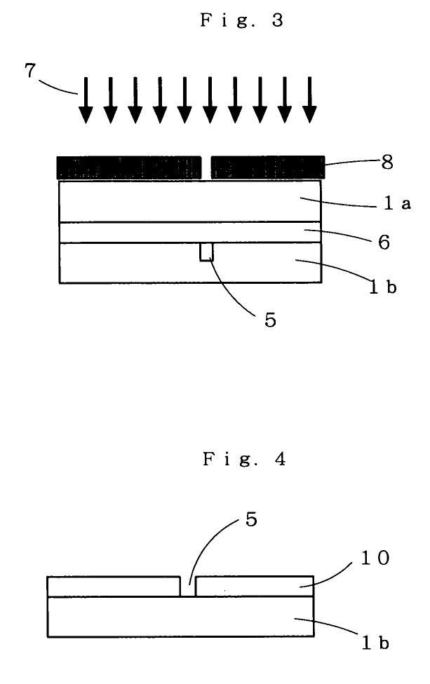

After that, as shown in FIG. 3, the obtained object was irradiated with ultraviolet rays of 3000 mJ/cm² by using a high-pressure mercury arc lamp via a photo mask 8 which is configured to expose only the groove 5 to the ultraviolet rays 7, thereby deconstructing a portion of the coating layer 6 corresponding to the groove and therefore facilitating the removal of the portion of the coating layer 6.

Then, tetramethyl ammonium hydroxide solution, of which concentration was 2.38% by mass, was flowed through the groove 5 at a temperature of 25° C. for 1 minute to cause alkali development of polysilane products within the groove 5, thereby removing the polysilane products. The inside of the groove 5 was further cleaned with purified water and was dried. After that, the obtained object was heated at a temperature of 270° C. for 30 minutes, thereby obtaining a cemented optical element as shown in FIG. 1. As a result of visual observation of the cemented optical element, there was no bubbles and no cracks, i.e. no cord in the cementing layer. The refraction index of the obtained polysilane was 1.57.

Since the quartz substrates 1a, 1b are bonded to each other with the transparent cementing layer having toughness higher than that of glass, the cemented optical element has high reliability of durability. Since the cementing layer within the groove 5 can be completely removed while assembly, the groove can be used as a fine micro fluid passage for instrumental analysis.

In case of the quartz substrates as mentioned above, a pattern layer having a desired groove is made of polysilane on one of the quartz substrate 1b and, after that, is completely vitrificated so that the desired pattern can be formed on the substrate before forming the cementing layer of polysilane.

For example, after applying the polysilane solution on the cementing surface of the quartz substrate 1b, in which the groove 5 will be formed, to have a thickness after dried corresponding to the depth of the groove 5 so as to form a coating layer, the quartz substrate 1b is dried in the dry kiln at a temperature of 120° C. for 40 minutes. After that, the quartz substrate 1b is irradiated with ultraviolet rays by using a photo mask which is configured to expose only a portion to be the groove 5 to the ultraviolet rays and then the quartz substrate 1b is entirely subjected to alkali development with tetramethyl ammonium hydroxide solution, thereby making the portion corresponding to the groove 5 to elute and removing the portion. After that, the quartz substrate was dried at a temperature of 200° C. for 30 minutes and then baked at a temperature of 600° C. for 30 minutes so as to vitrificate the polysilane, thereby obtaining a quartz substrate 1b having a vitrificated polysilane layer 10 as shown in FIG. 4.

### EXAMPLE 2

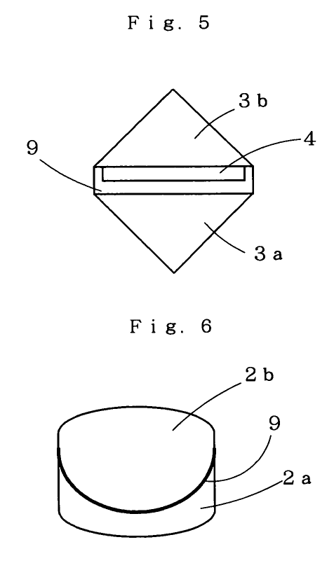

As shown in FIG. 5, a cemented optical element of Example 2 comprises a quartz prism 3a and a quartz prism 3b having an optical membrane 4 formed on its cementing surface. The guartz prisms 3a, 3b are bonded to each other via a cementing layer 9 made of polysilane to cover the optical membrane 4.

The cementing layer 9 made of polysilane was made by using polysilane solution similar to that of Example 1. The optical membrane 4 was a polarizing optical membrane consisting of 20 layers comprising titania layers and silica layers each having λ/4 thickness which were alternately laminated, wherein the preset wavelength is λ.

First, the cementing surface of the quartz prism 3a was held horizontally. Few spots of the polysilane solution were dropped on the cementing surface. The cementing surface of the other quartz prism 3b with the optical membrane 4 was superposed on the cementing surface of the quartz prism 3a, while the cementing layer is compressed with removing air. The overflowing polysilane solution was wiped off. The quartz prisms were dried in a dry kiln at a temperature of 120° C. for 2 hours to evaporate and remove the solvent while compressing and holding not to allow displacement. After that, the obtained object was irradiated with ultraviolet rays of 1000 mJ/cm² by using a high-pressure mercury arc lamp and further heated in a furnace at a temperature of 300° C. for 1 hour, thereby obtaining the cemented optical element. The thickness of the obtained polysilane layer was 5 μm.

The cemented optical element obtained in the aforementioned manner does not require such a high-temperature environment that has been required to the case using a fusing glass as cement and has improved optical characteristics in a range of short wavelength as compared to the case using an organic high-molecular bonding agent as cement. The cementing layer can be made of a material not containing any substance such as lead and thus having reduced environmental burden so that the cementing layer has no adverse affect on the optical membrane. Therefore, the cemented optical element can be used as a cemented optical element having high reliability of durability and can be adopted to an illumination system to be high temperature such as a polarizing beam splitter (PBS) and a beam splitter (BS) and a reflection optical system such as a half mirror.

### EXAMPLE 3

As shown in FIG. 6, a cemented optical element of Example 3 comprises a quartz lens 2a and a fluoric lens 2b which are bonded to each other via a cementing layer 9 made of polysilane. The polysilane used in this example is polysilane solution similar to that of Example 1.

Few spots of the polysilane solution similar to that of Example 1 were dropped on the cementing surface of the quartz lens 2a similarly to. The cementing surface of the fluoric lens 2b was superposed on the cementing surface of the quartz lens 2a, while the cementing layer is compressed with removing air. The overflowing polysilane solution was wiped off. The quartz lens 2a and the fluoric lens 2b were dried in a dry kiln at a temperature of 120° C. for 2 hours while compressing and holding not to allow displacement. After that, the obtained object was irradiated with ultraviolet rays of 1000 mJ/cm² by using a high-pressure mercury arc lamp and further heated in a furnace at a temperature of 300° C. for 1 hour, thereby obtaining the cemented optical element. The thickness of the obtained polysilane layer was 10 μm.

Even though the cemented lens as mentioned above is a combination of the quartz glass (0.5×10⁻⁶) and the fluorite (2.4×10⁻⁵) which have largely different coefficients of linear expansion, stripping does not occur after a heat cycle test by repeating 10 cycles in which one cycle involves the application of a temperature of 0° C. for 30 minutes, a temperature of 25° C. for 10 minutes, a temperature of 60° C. for 30 minutes, and a temperature of 25° C. for 10 minutes. Therefore, the cemented lens is a cemented optical element having high transparency and high reliability of durability over a range of wide wavelength and can be used as a cemented lens for various microscopes and endoscopes.

As mentioned in the above, according to the present invention, a cemented optical element is manufactured by bonding optical materials consisting of inorganic materials such as glass or ceramics via a cementing layer made of polysilane, thereby eliminating a complex film fabrication process and allowing the bonding at a relatively low temperature without causing such defects as damaging the optical characteristics. Accordingly, the present invention can provide a cemented optical element of which cementing layer has high toughness and which has high reliability of durability and can be easily manufactured and assembled without using a heavy metal such as lead.

In addition, the present invention can achieve the bonding between different materials, thereby providing cemented optical elements of various optical designs over a wider range.

The present invention can provide a cemented optical element with a cementing layer which does not peel off because it can absorb heat stress even when bonding different materials and which has improved flexibility and adhesiveness.

What we claim is:

1. A cemented optical element comprising optical materials consisting of inorganic material(s) which are bonded to each other via a cementing layer, wherein the cementing layer is made of polysilane.

2. A cemented optical element as claimed in claim 1, wherein the optical materials consisting of inorganic material(s) are at least two different materials.

3. A cemented optical element as claimed in claim 1 or 2, wherein the cementing layer made of polysilane is formed by applying polysilane solution containing a photo-curable component on a cementing portion and, after that, curing the polysilane solution by irradiation of light.

4. A cemented optical element as claimed in any one of claims 1 through 3, wherein the cementing layer made of polysilane is formed by heating at a temperature between 250° C. and 350° C.
